(19) United States
(12) Patent Application Publication
(10) Pub. No.: US 2023/0343127 A1
(43) Pub. Date: Oct. 26, 2023

(54) HOUSEHOLD APPLIANCE WITH SMART PROTECTED USER DETECTION

(71) Applicant: Haier US Appliance Solutions, Inc., Wilmington, DE (US)

(72) Inventors: Haitian Hu, Louisville, KY (US); Hairong Li, Louisville, KY (US); Daniel Stephen Renz, Louisville, KY (US); James Quentin Pollett, Louisville, KY (US); Tyler James Doering, Louisville, KY (US)

(21) Appl. No.: 17/725,734

(22) Filed: Apr. 21, 2022

(51) Int. Cl. G06V 40/10; G06V 40/50; G06F 21/32; H04N 7/18

(52) U.S. Cl. CPC G06V 40/10; G06F 21/32; G06V 40/50; H04N 7/183; G08B 21/24

(57) ABSTRACT

A method of operating a household appliance, where the household appliance includes a camera assembly operable to obtain an image, is provided. The method includes downloading a protected user detection software from a remote computing device to the household appliance. The method also includes unlocking a user interface of the household appliance. The method further includes detecting, with the camera assembly, a user at the household appliance after unlocking the user interface and using the protected user detection software to determine that the detected user is a protected user. In response to detecting the protected user, the user interface is locked.

### FIELD OF THE INVENTION

The present subject matter relates generally to household appliances, such as one or more laundry appliances, and more particularly to systems and methods for detecting protected users of such appliances.

### BACKGROUND OF THE INVENTION

Household appliances are utilized generally for a variety of tasks by a variety of users. For example, a household may include such appliances as laundry appliances, e.g., a washer and/or dryer, kitchen appliances, e.g., a refrigerator, a dishwasher, etc., along with room air conditioners and other various appliances.

In many situations, operation of a household appliance by certain users may be undesirable. For example, some household appliances may include features which generate high levels of heat, e.g., burners on a cooktop or oven appliance, and/or may include enclosable internal volumes, such as inside of a drum of a dryer appliance, a wash basket of a washing machine appliance, or a food storage compartment in a refrigerator or freezer appliance. Accordingly, many household appliances include components or features which are not desired for certain users, such as children or elderly, etc., to have unlimited access to.

Accordingly, an appliance with improved features for restricting or preventing protected users from operating the appliance unattended would be useful. More particularly, an appliance that is capable of identifying a protected user, and methods of identifying a protected user, would be useful.

### BRIEF DESCRIPTION OF THE INVENTION

Aspects and advantages of the invention will be set forth in part in the following description, or may be apparent from the description, or may be learned through practice of the invention.

In an exemplary embodiment, a method of operating a household appliance is provided. The household appliance includes a camera assembly operable to obtain an image. The method includes downloading a protected user detection software from a remote computing device to the household appliance. The method also includes unlocking a user interface of the household appliance and detecting a user at the household appliance after unlocking the user interface of the household appliance. The user is detected with the camera assembly. The method further includes determining whether the detected user is a protected user. The determination is made using the protected user detection software. The method also includes locking the user interface of the household appliance in response to determining that the detected user is the protected user.

In another exemplary embodiment, a household appliance is provided. The household appliance includes a camera assembly operable to obtain an image and a controller. The controller is operable for downloading a protected user detection software from a remote computing device to the household appliance. The controller is also operable for unlocking a user interface of the household appliance and detecting, with the camera assembly, a user at the household appliance after unlocking the user interface of the household appliance. The controller is further operable for determining, using the protected user detection software, whether the detected user is a protected user and locking the user interface of the household appliance in response to determining that the detected user is the protected user.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front view of exemplary household appliances, e.g., an exemplary washing machine appliance and an exemplary dryer appliance in accordance with one or more exemplary embodiments of the present disclosure.

FIG. 2 provides a transverse cross-sectional view of the exemplary washing machine appliance of FIG. 1.

FIG. 3 provides a perspective view of the exemplary dryer appliance of FIG. 1 with portions of a cabinet of the dryer appliance removed to reveal certain components of the dryer appliance.

FIG. 4 provides a diagrammatic illustration of a household appliance in communication with a remote computing device and with a remote user interface device according to one or more exemplary embodiments of the present subject matter.

FIG. 5 provides a flow diagram of an exemplary method for operating a household appliance according to one or more exemplary embodiments of the present subject matter.

FIG. 6 provides a flow diagram of an additional exemplary method for operating a household appliance according to one or more exemplary embodiments of the present subject matter.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Directional terms such as “left” and “right” are used herein with reference to the perspective of a user standing in front of a household appliance to access the appliance and/or items therein. Terms such as “inner” and “outer” refer to relative directions with respect to the interior and exterior of the appliance. For example, “inner” or “inward” refers to the direction towards the interior of the appliance. Terms such as “left,” “right,” “front,” “back,” “top,” or “bottom” are used with reference to the perspective of a user accessing the appliance. For example, a user stands in front of the appliance to open the door(s) and reaches into the appliance to add, move, or withdraw items therein.

As used herein, the terms “first,” “second,” and “third” may be used interchangeably to distinguish one component from another and are not intended to signify location or importance of the individual components. As used herein, terms of approximation, such as “generally,” or “about” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

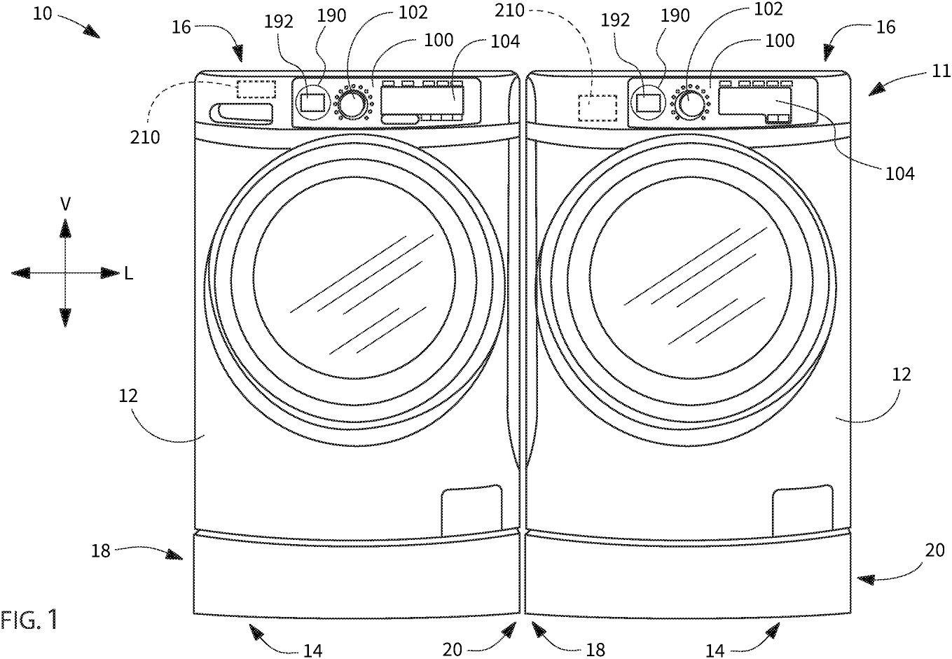

Exemplary household appliances are illustrated in FIGS. 1 through 3, e.g., the household appliance may, in various embodiments, be a laundry appliance such as a washing machine appliance or a dryer appliance. In various embodiments of the present subject matter, a laundry appliance may be any suitable laundry appliance, such as a washing machine appliance, a dryer appliance, a combination washer-dryer appliance, etc. The dryer appliance 11 is separately labelled in FIG. 1 to distinguish the dryer appliance 11 from the washing machine appliance 10, where both the washing machine appliance 10 and the dryer appliance 11 are example embodiments of a household appliance 10 which may be usable in one or more exemplary methods described herein and/or may be operable and configured to perform such methods.

According to various embodiments of the present disclosure, the household appliance 10 may take the form of any of the example laundry appliances described herein, or may be any other household appliance. Thus, it will be understood that the present subject matter is not limited to any particular household appliance.

It should be understood that “household appliance” and/or “appliance” are used herein to describe appliances typically used or intended for common domestic tasks, such as a laundry appliance, e.g., as illustrated in FIGS. 1 through 3, or an air conditioner appliance, a dishwashing appliance, a refrigerator, a water heater, etc., and any other household appliance which performs similar functions in addition to network communication and data processing. Thus, devices such as a personal computer, router, and other similar devices whose primary functions are network communication and/or data processing are not considered household appliances as used herein.

As may be seen generally throughout FIGS. 1 through 3, a user interface panel 100 and a user input device 102 may be positioned on an exterior of the laundry appliance. The user input device 102 is generally positioned proximate to the user interface panel 100, and in some embodiments, the user input device 102 may be positioned on the user interface panel 100.

In various embodiments, the user interface panel 100 may represent a general purpose I/O (“GPIO”) device or functional block. In some embodiments, the user interface panel 100 may include or be in operative communication with user input device 102, such as one or more of a variety of digital, analog, electrical, mechanical or electro-mechanical input devices including rotary dials, control knobs, push buttons, and touch pads. The user interface panel 100 may include a display component 104, such as a digital or analog display device designed to provide operational feedback to a user. The display component 104 may also be a touchscreen capable of receiving a user input, such that the display component 104 may also be a user input device in addition to or instead of the user input device 102.

Generally, each appliance may include a controller 210 in operative communication with the user input device 102. The user interface panel 100 and the user input device 102 may be in communication with the controller 210 via, for example, one or more signal lines or shared communication busses. Input/output (“I/O”) signals may be routed between controller 210 and various operational components of the appliance. Operation of the appliance can be regulated by the controller 210 that is operatively coupled to the user interface panel 100. A user interface panel 100 may for example provide selections for user manipulation of the operation of an appliance, e.g., via user input device 102 and/or display 104. In response to user manipulation of the user interface panel 100 and/or user input device 102, the controller 210 may operate various components of the appliance. Controller 210 may include a memory and one or more microprocessors, CPUs or the like, such as general or special purpose microprocessors operable to execute programming instructions or micro-control code associated with operation of the appliance. The memory may represent random access memory such as DRAM, or read only memory such as ROM or FLASH. In one embodiment, the processor executes programming instructions stored in memory. The memory may be a separate component from the processor or may be included onboard within the processor. Alternatively, a controller 210 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

The controller 210 may be programmed to operate the appliance by executing instructions stored in memory. For example, the instructions may be software or any set of instructions that when executed by the processing device, cause the processing device to perform operations. Controller 210 can include one or more processor(s) and associated memory device(s) configured to perform a variety of computer-implemented functions and/or instructions (e.g. performing the methods, steps, calculations and the like and storing relevant data as disclosed herein). It should be noted that controllers 210 as disclosed herein are capable of and may be operable to perform any methods and associated method steps as disclosed herein.

As generally seen throughout FIGS. 1 through 3, in at least some embodiments, each laundry appliance 10 and 11 includes a cabinet 12 which defines a vertical direction V, a lateral direction L, and a transverse direction T that are mutually perpendicular. Each cabinet 12 extends between a top side 16 and a bottom side 14 along the vertical direction V. Each cabinet 12 also extends between a left side 18 and a right side 20, e.g., along the lateral direction L, and between a front side 22 and a rear side 24 along the transverse direction T.

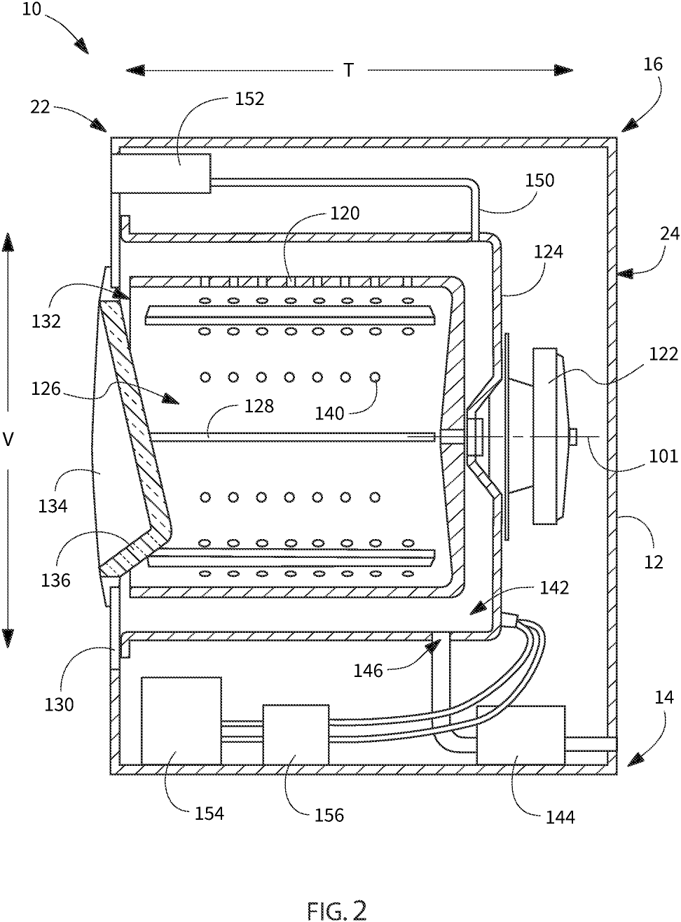

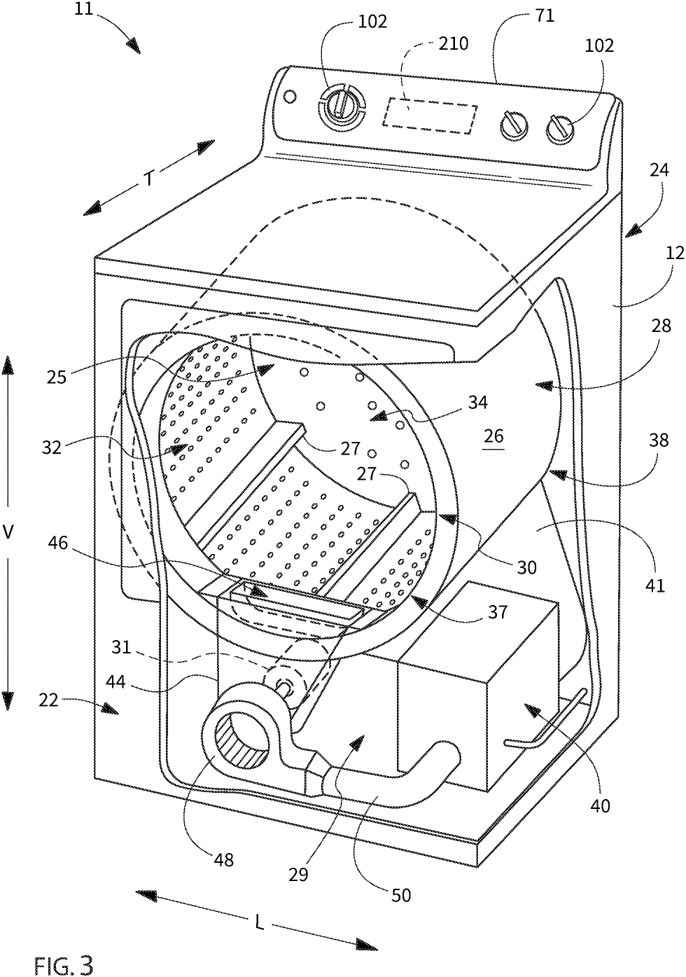

Additional exemplary details of each laundry appliance are illustrated in FIGS. 2 and 3. For example, FIG. 2 provides a cross-sectional view of the exemplary washing machine appliance 10. As illustrated in FIG. 2, a wash tub 124 is non-rotatably mounted within cabinet 12. As may be seen in FIG. 2, the wash tub 124 defines a central axis 101. In the example embodiment illustrated by FIG. 2, the central axis 101 may be oriented generally along or parallel to the transverse direction T of the washing machine appliance 10. Accordingly, the washing machine appliance 10 may be referred to as a horizontal axis washing machine.

Referring again to FIG. 2, a wash basket 120 is rotatably mounted within the tub 124 such that the wash basket 120 is rotatable about an axis of rotation, which generally coincides with central axis 101 of the tub 124. A motor 122, e.g., such as a pancake motor, is in mechanical communication with wash basket 120 to selectively rotate wash basket 120 (e.g., during an agitation or a rinse cycle of washing machine appliance 10). Wash basket 120 defines a wash chamber 126 that is configured for receipt of articles for washing. The wash tub 124 holds wash and rinse fluids for agitation in wash basket 120 within wash tub 124. As used herein, “wash fluid” may refer to water, detergent, fabric softener, bleach, or any other suitable wash additive or combination thereof. The wash basket 120 and the tub 124 may collectively define at least a portion of a tub assembly for the washing machine appliance 10.

Wash basket 120 may define one or more agitator features that extend into wash chamber 126 to assist in agitation and cleaning of articles disposed within wash chamber 126 during operation of washing machine appliance 10. For example, as illustrated in FIG. 2, a plurality of ribs 128 extends from basket 120 into wash chamber 126. In this manner, for example, ribs 128 may lift articles disposed in wash basket 120 during rotation of wash basket 120.

Referring generally to FIGS. 1 and 2, cabinet 12 also includes a front panel 130 which defines an opening 132 that permits user access to wash basket 120 within wash tub 124. More specifically, washing machine appliance 10 includes a door 134 that is positioned in front of opening 132 and is rotatably mounted to front panel 130. Door 134 is rotatable such that door 134 permits selective access to opening 132 by rotating between an open position (not shown) facilitating access to a wash tub 124 and a closed position (FIG. 1) prohibiting access to wash tub 124.

A window 136 in door 134 permits viewing of wash basket 120 when door 134 is in the closed position, e.g., during operation of washing machine appliance 10. Door 134 also includes a handle (not shown) that, e.g., a user may pull when opening and closing door 134. Further, although door 134 is illustrated as mounted to front panel 130, it should be appreciated that door 134 may be mounted to another side of cabinet 12 or any other suitable support according to alternative embodiments.

Referring again to FIG. 2, wash basket 120 also defines a plurality of perforations 140 in order to facilitate fluid communication between an interior of basket 120 and wash tub 124. A sump 142 is defined by wash tub 124 at a bottom of wash tub 124 along the vertical direction V. Thus, sump 142 is configured for receipt of and generally collects wash fluid during operation of washing machine appliance 10. For example, during operation of washing machine appliance 10, wash fluid may be urged by gravity from basket 120 to sump 142 through plurality of perforations 140. A pump assembly 144 is located beneath tub 124 for gravity assisted flow when draining tub 124, e.g., via a drain 146. Pump assembly 144 may be configured for recirculating wash fluid within wash tub 124.

A spout 150 is configured for directing a flow of fluid into wash tub 124. For example, spout 150 may be in fluid communication with a water supply (not shown) in order to direct fluid (e.g., clean water) into wash tub 124. Spout 150 may also be in fluid communication with the sump 142. For example, pump assembly 144 may direct wash fluid disposed in sump 142 to spout 150 in order to circulate wash fluid in wash tub 124.

As illustrated in FIG. 2, a detergent drawer 152 is slidably mounted within front panel 130. Detergent drawer 152 receives a wash additive (e.g., detergent, fabric softener, bleach, or any other suitable liquid or powder) and directs the fluid additive to wash chamber 124 during operation of washing machine appliance 10. According to the illustrated embodiment, detergent drawer 152 may also be fluidly coupled to spout 150 to facilitate the complete and accurate dispensing of wash additive.

Additionally, a bulk reservoir 154 is disposed within cabinet 12. Bulk reservoir 154 is also configured for receipt of fluid additive for use during operation of washing machine appliance 10. Bulk reservoir 154 is sized such that a volume of fluid additive sufficient for a plurality or multitude of wash cycles of washing machine appliance 10 (e.g., five, ten, twenty, fifty, or any other suitable number of wash cycles) may fill bulk reservoir 154. Thus, for example, a user can fill bulk reservoir 154 with fluid additive and operate washing machine appliance 10 for a plurality of wash cycles without refilling bulk reservoir 154 with fluid additive. A reservoir pump 156 is configured for selective delivery of the fluid additive from bulk reservoir 154 to wash tub 124.

During operation of washing machine appliance 10, e.g., during a wash cycle of the washing machine appliance 10, a laundry items are loaded into wash basket 120 through opening 132, and washing operation is initiated through operator manipulation of input selectors 102. Wash tub 124 is filled with water, detergent, and/or other fluid additives, e.g., via spout 150 and/or detergent drawer 152. One or more valves (not shown) can be controlled by washing machine appliance 10 to provide for filling wash basket 120 to the appropriate level for the amount of articles being washed and/or rinsed. By way of example for a wash mode, once wash basket 120 is properly filled with fluid, the contents of wash basket 120 can be agitated (e.g., with ribs 128) for washing of laundry items in wash basket 120.

After the agitation phase of the wash cycle is completed, wash tub 124 can be drained. Laundry articles can then be rinsed by again adding fluid to wash tub 124, depending on the particulars of the cleaning cycle selected by a user. Ribs 128 may again provide agitation within wash basket 120. One or more spin cycles may also be used. In particular, a spin cycle may be applied after the wash cycle and/or after the rinse cycle in order to wring wash fluid from the articles being washed. During a spin cycle, basket 120 is rotated at relatively high speeds. After articles disposed in wash basket 120 are cleaned and/or washed, the user can remove the articles from wash basket 120, e.g., by opening door 134 and reaching into wash basket 120 through opening 132.

While described in the context of a specific embodiment of horizontal axis washing machine appliance 10, using the teachings disclosed herein it will be understood that horizontal axis washing machine appliance 10 is provided by way of example only. It should be appreciated that the present subject matter is not limited to any particular style, model, or configuration of washing machine appliance. Other washing machine appliances having different configurations, different appearances, and/or different features may also be utilized with the present subject matter as well, e.g., vertical axis washing machine appliances.

FIG. 3 provides a perspective view of the dryer appliance 11 of FIG. 1, which is an example embodiment of a laundry appliance, and is an example embodiment of a household appliance 10, with a portion of a cabinet or housing 12 of dryer appliance 11 removed in order to show certain components of dryer appliance 11. Dryer appliance 11 generally defines a vertical direction V, a lateral direction L, and a transverse direction T, each of which is mutually perpendicular, such that an orthogonal coordinate system is defined. While described in the context of a specific embodiment of dryer appliance 11, using the teachings disclosed herein, it will be understood that dryer appliance 11 is provided by way of example only. Other dryer appliances having different appearances and different features may also be utilized with the present subject matter as well.

Cabinet 12 includes a front side 22 and a rear side 24 spaced apart from each other along the transverse direction T. Within cabinet 12, an interior volume 29 is defined. A drum or container 26 is mounted for rotation about a substantially horizontal axis within the interior volume 29. Drum 26 defines a chamber 25 for receipt of articles of clothing for tumbling and/or drying. Drum 26 extends between a front portion 37 and a back portion 38. Drum 26 also includes a back or rear wall 34, e.g., at back portion 38 of drum 26. A supply duct 41 may be mounted to rear wall 34 and receives heated air that has been heated by a heating assembly or system 40.

As used herein, the terms “clothing” or “articles” includes but need not be limited to fabrics, textiles, garments, linens, papers, or other items from which the extraction of moisture is desirable. Furthermore, the term “load” or “laundry load” refers to the combination of clothing or articles that may be washed together in a washing machine or dried together in a dryer appliance 11 (e.g., clothes dryer) and may include a mixture of different or similar articles of clothing of different or similar types and kinds of fabrics, textiles, garments and linens within a particular laundering process.

A motor 31 is provided in some embodiments to rotate drum 26 about the horizontal axis, e.g., via a pulley and a belt (not pictured). Drum 26 is generally cylindrical in shape, having an outer cylindrical wall 28 and a front flange or wall 30 that defines an opening 32 of drum 26, e.g., at front portion 37 of drum 26, for loading and unloading of articles into and out of chamber 25 of drum 26. A plurality of lifters or baffles 27 are provided within chamber 25 of drum 26 to lift articles therein and then allow such articles to tumble back to a bottom of drum 26 as drum 26 rotates. Baffles 27 may be mounted to drum 26 such that baffles 27 rotate with drum 26 during operation of dryer appliance 11.

The rear wall 34 of drum 26 may be rotatably supported within the cabinet 12 by a suitable fixed bearing. Rear wall 34 can be fixed or can be rotatable. Rear wall 34 may include, for instance, a plurality of holes that receive hot air that has been heated by heating system 40. The heating system 40 may include, e.g., a heat pump, an electric heating element, and/or a gas heating element (e.g., gas burner). Moisture laden, heated air is drawn from drum 26 by an air handler, such as blower fan 48, which generates a negative air pressure within drum 26. The moisture laden heated air passes through a duct 44 enclosing screen filter 46, which traps lint particles. As the air passes from blower fan 48, it enters a duct 50 and then is passed into heating system 40. In some embodiments, the dryer appliance 11 may be a conventional dryer appliance, e.g., the heating system 40 may be or include an electric heating element, e.g., a resistive heating element, or a gas-powered heating element, e.g., a gas burner. In other embodiments, the dryer appliance may be a condensation dryer, such as a heat pump dryer. In such embodiments, heating system 40 may be or include a heat pump including a sealed refrigerant circuit. Heated air (with a lower moisture content than was received from drum 26), exits heating system 40 and returns to drum 26 by duct 41. After the clothing articles have been dried, they are removed from the drum 26 via opening 32. A door (FIG. 1) provides for closing or accessing drum 26 through opening 32.

In some embodiments, one or more selector inputs 102, such as knobs, buttons, touchscreen interfaces, etc., may be provided or mounted on the cabinet 12 (e.g., on a backsplash 71) and are in operable communication (e.g., electrically coupled or coupled through a wireless network band) with the processing device or controller 210. Controller 210 may also be provided in operable communication with components of the dryer appliance 11 including motor 31, blower 48, or heating system 40. In turn, signals generated in controller 210 direct operation of motor 31, blower 48, or heating system 40 in response to the position of inputs 102. As used herein, “processing device” or “controller” may refer to one or more microprocessors, microcontroller, ASICS, or semiconductor devices and is not restricted necessarily to a single element. The controller 210 may be programmed to operate dryer appliance 11 by executing instructions stored in memory (e.g., non-transitory media). The controller 56 may include, or be associated with, one or more memory elements such as RAM, ROM, or electrically erasable, programmable read only memory (EEPROM). For example, the instructions may be software or any set of instructions that when executed by the processing device, cause the processing device to perform operations. It should be noted that controllers as disclosed herein are capable of and may be operable to perform any methods and associated method steps as disclosed herein. For example, in some embodiments, methods disclosed herein may be embodied in programming instructions stored in the memory and executed by the controller 210.

User interface panel 100, including user input device 102 and display 104 thereon, provides a user interface, e.g., a means for users to communicate with and operate the household appliance 10. It will be appreciated that other components or devices that provide for communication with household appliance 10 for operating household appliance 10 may also be included in the user interface. For example, the user interface may include a speaker, a microphone, a camera (still or video) or motion detection camera for detecting a user’s proximity to household appliance 10 or for picking up certain motions, and/or other user interface elements in various combinations.

As will be described in more detail below, household appliance 10 may further include features that are generally configured to detect the presence and identity of a user, in particular of a protected user, such as one of a group of protected users. More specifically, such features may include one or more sensors, e.g., cameras 192 (see, e.g., FIG. 1), or other detection devices that are used to monitor the household appliance 10 and an area in front of the cabinet 12, such as an area in which a user accessing the household appliance 10 is likely to be present. The sensors or other detection devices may be operable to detect and monitor presence of one or more users that are accessing the household appliance 10. In this regard, the household appliance 10 may use data from each of these devices to obtain a representation or knowledge of the identity, position, and/or other qualitative or quantitative characteristics of one or more users.

As shown schematically in FIG. 1, the user detection system may include a camera assembly 190 that is generally positioned and configured for obtaining images of the household appliance 10 and adjoining areas, e.g., in front of the household appliance 10, during operation of the camera assembly 190. In some exemplary embodiments, e.g., as illustrated in FIG. 1, camera assembly 190 includes one or more cameras 192. The one or more cameras 192 may be mounted to cabinet 12 or otherwise positioned in view of an area in front of the cabinet 12. As shown in FIG. 1, a camera 192 of camera assembly 190 is mounted to user interface panel 100 at the front side 22 of cabinet 12 and is forward-facing, e.g., is oriented to have a field of vision or field of view directed towards an area in front of the cabinet 12, such as directly and immediately in front of the cabinet 12.

Although a single camera 192 is illustrated in FIG. 1, it should be appreciated that camera assembly 190 may include a plurality of cameras 192, wherein each of the plurality of cameras 192 has a specified monitoring zone or range positioned in and/or around household appliance 10, such as multiple cameras oriented in or facing various directions, and/or a second forward-facing camera. In this regard, for example, the field of view of each camera 192 may be limited to or focused on a specific area.

In some embodiments, it may be desirable to activate the camera or cameras 192 for limited time durations and only in response to certain triggers. For example, a proximity sensor, such as an infrared (IR) camera, may be provided such that the camera 192 is only activated after the proximity sensor detects motion at the front of the household appliance 10. In additional embodiments, the activation of the camera 192 may be in response to an interaction with the household appliance, such as a door opening, such as detecting that a door of the household appliance 10, such as the door 134 of the washing machine appliance or the door of the dryer appliance, was opened using a door switch, or an interaction with the user interface, such as pressing a button or touching a touchscreen control, etc. In this manner, privacy concerns related to obtaining images of the user of the household appliance 10 may be mitigated. According to exemplary embodiments, camera assembly 190 may be used to facilitate a user detection and/or identification process for the household appliance 10. As such, each camera 192 may be positioned and oriented to monitor one or more areas of the household appliance 10 and adjoining areas, such as while a user is accessing or attempting to access the household appliance 10.

It should be appreciated that according to alternative embodiments, camera assembly 190 may include any suitable number, type, size, and configuration of camera(s) 192 for obtaining images of any suitable areas or regions within or around household appliance 10. In addition, it should be appreciated that each camera 192 may include features for adjusting the field of view and/or orientation.

It should be appreciated that the images obtained by camera assembly 190 may vary in number, frequency, angle, resolution, detail, etc. in order to improve the clarity of the particular regions surrounding or within household appliance 10. In addition, according to exemplary embodiments, controller 210 may be configured for illuminating the household appliance 10 and/or surrounding areas using one or more light sources prior to obtaining images. Notably, controller 210 of household appliance 10 (or any other suitable dedicated controller) may be communicatively coupled to camera assembly 190 and may be programmed or configured for analyzing the images obtained by camera assembly 190, e.g., in order to detect and/or identify a user proximate to the household appliance 10, as described in more detail below.

In general, controller 210 may be operably coupled to camera assembly 190 for analyzing one or more images obtained by camera assembly 190 to extract useful information regarding objects or people within the field of view of the one or more cameras 192. In this regard, for example, images obtained by camera assembly 190 may be used to extract a facial image or other identifying information related to one or more users. Notably, this analysis may be performed locally (e.g., on controller 210) or may be transmitted to a remote server (e.g., in the “cloud,” as those of ordinary skill in the art will recognize as referring to a remote server or database in a distributed computing environment including at least one remote computing device) for analysis. Such analysis is intended to facilitate user detection, e.g., by identifying a user accessing the household appliance, such as a user who may be operating, e.g., activating or adjusting, one or more components of the household appliance 10 or otherwise accessing the household appliance 10. As will be described in more detail below, such identification may also include determining whether the user is a protected user such as a child, an elderly or infirm person, a disabled person, etc. Additionally, it should be noted that the protected user or users are not necessarily only people, for example, animals such as a dog or cat may also be included in the group of protected users.

Specifically, according to an exemplary embodiment as illustrated in FIG. 1, camera 192 (or multiple cameras 192 in the camera assembly 190 collectively) may be oriented away from a center of cabinet 12 and define a field of view that covers an area in front of cabinet 12. In this manner, the field of view of camera 192, and the resulting images obtained, may capture any motion or movement of a user accessing or operating the household appliance. The images obtained by camera assembly 190 may include one or more still images, one or more video clips, or any other suitable type and number of images suitable for detection and/or identification of a user.

Notably, camera assembly 190 may obtain images upon any suitable trigger, such as a time-based imaging schedule where camera assembly 190 periodically images and monitors the field of view, e.g., in and/or in front of the household appliance 10. According to still other embodiments, camera assembly 190 may periodically take low-resolution images until motion (such as approaching the household appliance 10, opening a door thereof, or reaching for one of the controls or user inputs thereof) is detected (e.g., via image differentiation of low-resolution images), at which time one or more high-resolution images may be obtained. According to still other embodiments, household appliance 10 may include one or more motion sensors (e.g., optical, acoustic, electromagnetic, etc.) that are triggered when an object or user moves into or through the area in front of the household appliance 10, and camera assembly 190 may be operably coupled to such motion sensors to obtain images of the object during such movement. In some embodiments, the camera assembly 190 may only obtain images when the household appliance is activated, as will be understood by those of ordinary skill in the art. Thus, for example, when the household appliance 10 is operating, the camera assembly 190 may then continuously or periodically obtain images, or may apply the time-based imaging schedule, motion detection based imaging, or other imaging routines/schedules throughout the time that the household appliance 10 is operating.

It should be appreciated that the images obtained by camera assembly 190 may vary in number, frequency, angle, resolution, detail, etc. in order to improve the clarity thereof. In addition, according to exemplary embodiments, controller 210 may be configured for illuminating a light (not shown) while obtaining the image or images. Other suitable imaging triggers are possible and within the scope of the present subject matter.

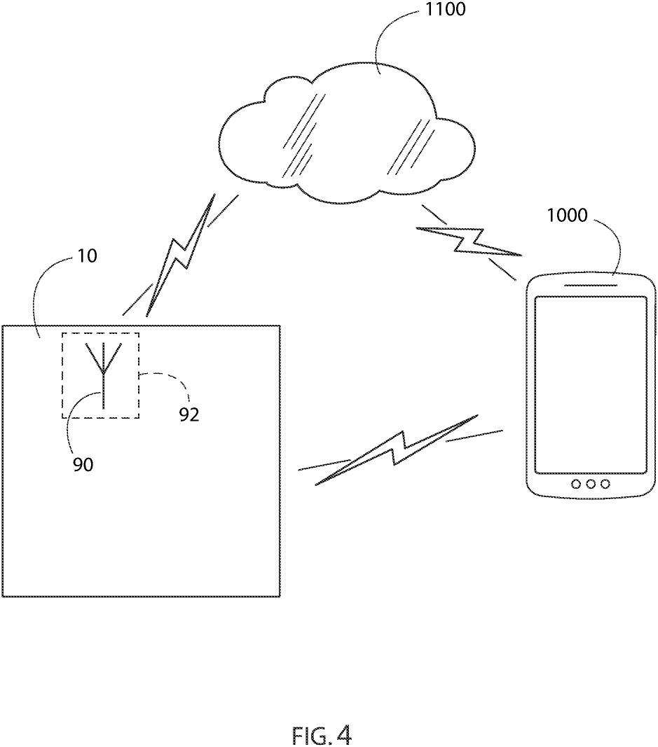

Turning now to FIG. 4, a general schematic is provided of a household appliance 10, which communicates wirelessly with a remote user interface device 1000 and a network 1100. For example, as illustrated in FIG. 4, the household appliance 10 may include an antenna 90 by which the household appliance 10 communicates with, e.g., sends and receives signals to and from, the remote user interface device 1000 and/or network 1100. The antenna 90 may be part of, e.g., onboard, a communications module 92. The communications module 92 may be a wireless communications module operable to connect wirelessly, e.g., over the air, to one or more other devices via any suitable wireless communication protocol. For example, the communications module 92 may be a WI-FI® module, a BLUETOOTH® module, or a combination module providing both WI-FI® and BLUETOOTH® connectivity. The remote user interface device 1000 may be a laptop computer, smartphone, tablet, personal computer, wearable device, smart speaker, smart home system, and/or various other suitable devices. The communications module 92 may be onboard the controller 210 or may be a separate module.

The household appliance 10 may be in communication with the remote user interface device 1000 device through various possible communication connections and interfaces. The household appliance 10 and the remote user interface device 1000 may be matched in wireless communication, e.g., connected to the same wireless network. The household appliance 10 may communicate with the remote user interface device 1000 via short-range radio such as BLUETOOTH® or any other suitable wireless network having a layer protocol architecture. As used herein, “short-range” may include ranges less than about ten meters and up to about one hundred meters. For example, the wireless network may be adapted for short-wavelength ultra-high frequency (UHF) communications in a band between 2.4 GHz and 2.485 GHz (e.g., according to the IEEE 802.15.1 standard). In particular, BLUETOOTH® Low Energy, e.g., BLUETOOTH® Version 4.0 or higher, may advantageously provide short-range wireless communication between the household appliance 10 and the remote user interface device 1000. For example, BLUETOOTH® Low Energy may advantageously minimize the power consumed by the exemplary methods and devices described herein due to the low power networking protocol of BLUETOOTH® Low Energy.

The remote user interface device 1000 is “remote” at least in that it is spaced apart from and not physically connected to the household appliance 10, e.g., the remote user interface device 1000 is a separate, stand-alone device from the household appliance 10 which communicates with the household appliance 10 wirelessly. Any suitable device separate from the household appliance 10 that is configured to provide and/or receive communications, information, data, or commands from a user may serve as the remote user interface device 1000, such as a smartphone (e.g., as illustrated in FIG. 4), smart watch, personal computer, smart home system, or other similar device. For example, the remote user interface device 1000 may be a smartphone operable to store and run applications, also known as “apps,” and some or all of the method steps disclosed herein may be performed by a smartphone app.

The remote user interface device 1000 may include a memory for storing and retrieving programming instructions. Thus, the remote user interface device 1000 may provide a remote user interface which may be an additional user interface to the user interface panel 100. For example, the remote user interface device 1000 may be a smartphone operable to store and run applications, also known as “apps,” and the additional user interface may be provided as a smartphone app.

As mentioned above, the household appliance 10 may also be configured to communicate wirelessly with a network 1100. The network 1100 may be, e.g., a cloud-based data storage system including one or more remote computing devices such as remote databases and/or remote servers, which may be collectively referred to as “the cloud.” For example, the household appliance 10 may communicate with the cloud 1100 over the Internet, which the household appliance 10 may access via WI-FI®, such as from a WI-FI® access point in a user’s home.

Exemplary methods for operating a household appliance, such as a laundry appliance, as described above, are provided. In this regard, for example, a controller of the household appliance, e.g., controller 210, may be configured for implementing some or all steps of one or more of the following exemplary methods. However, it should be appreciated that the exemplary methods are discussed herein only to describe exemplary aspects of the present subject matter, and are not intended to be limiting.

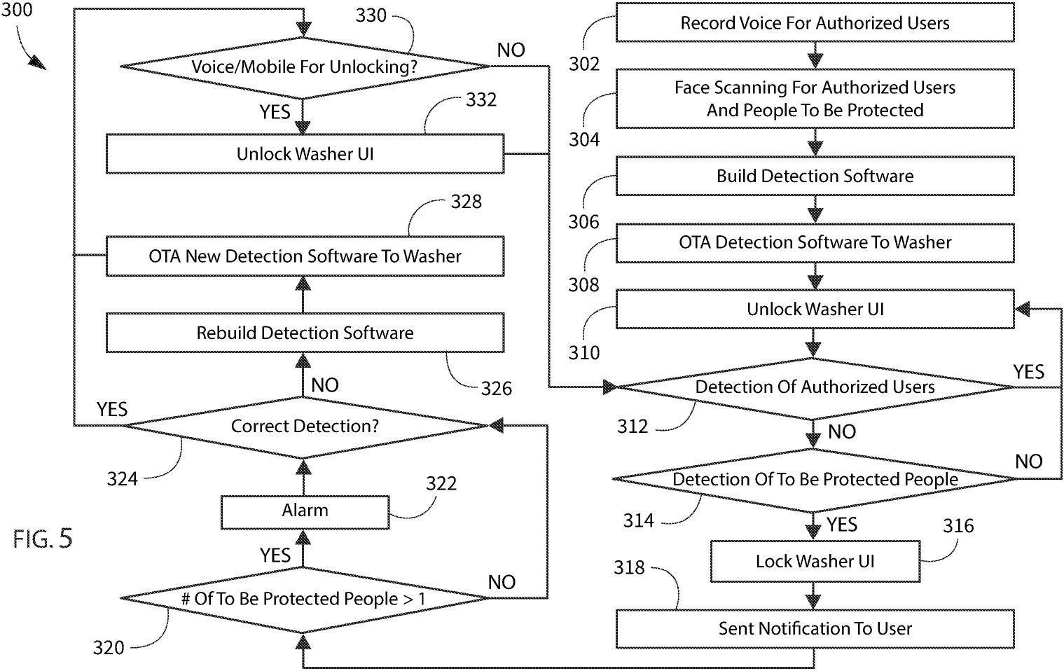

An exemplary method 300 of operating a household appliance is illustrated in FIG. 5. In FIG. 5 and the accompanying description, the household appliance is a washing machine appliance (sometimes also referred to as a “washer”), by way of example. This example is provided for illustrative purposes only. FIG. 5 also references protected people, as an example of protected users. In various embodiments, the protected user or users in methods according to the present disclosure may include people such as children, elderly persons, persons with physical and/or intellectual disability, as well as non-human “users,” such as pets who may interact with the household appliance, e.g., jump on or into the household appliance, which may inadvertently activate the household appliance, or other users who may not be suitable for unsupervised or unassisted operation of the household appliance.

As illustrated in FIG. 5, the method 300 may include one or more steps for capturing biometric data from various users. For example, method 300 may include a step 302 of recording biometric data, e.g., a voice, of one or more authorized users and a step 304 scanning the faces of both the authorized users and protected users, e.g., children, elderly, pets, etc. For example, the users’ faces may be scanned with a camera assembly of the household appliance, e.g., such as the camera assembly described above with respect to FIG. 1, or a remote user interface device, e.g., as described above with respect to FIG. 4, or any other suitable image-capture device which can communicate (directly or indirectly) with the household appliance and/or one or more remote computing devices. The scanned images of the face of the one or more authorized users and the one or more protected users may then be uploaded to a database of faces, such as a remote database, such as in the cloud.

The database of face images may then be used to build protected user detection software as indicated at 306 in FIG. 5. The protected user detection software may be built, e.g., by the remote computing device. Thus, method 300 may further include a step 308 of downloading the protected user detection software, such as over the air (“OTA”), e.g., wirelessly, from the remote computing device to the household appliance, e.g., washer as indicated in the illustrated exemplary embodiment of FIG. 5.

As illustrated at steps 310, 312, and 314 in FIG. 5, when a user interface of the household appliance is unlocked whereby the household appliance, e.g., one or more mechanical components thereof, may be activated, such as turning on one or more burners or heating elements, activating a motor or pump, etc., the method 300 may then begin searching for protected users. For example, as specifically illustrated in FIG. 5, the method 300 may include an unlocking step 310 of unlocking the user interface of the household appliance.

When the user interface of the household appliance 10 is unlocked, e.g., after the unlocking at step 310 in FIG. 5, the method 300 then proceeds to detect authorized users, e.g., as noted at 312 in FIG. 3, and may further proceed to step 314 of detecting protected users, e.g., people. Step 312 and/or step 314 may include activating one or more cameras of a camera assembly of the household appliance to obtain images of the household appliance and/or areas proximate thereto, such as in front of the household appliance, for example as described above.

As long as at least one authorized user is present, e.g., when the detection at step 312 is positive, the user interface may remain unlocked, e.g., method 300 may loop back to step 310 as illustrated in FIG. 5, after which the method 300 may continue to iterate and continue to monitor for the presence of authorized users while the user interface is unlocked.

When an authorized user is not detected at step 312, the method 300 may continue to a step 314 of detecting one or more protected users, e.g., people. If a protected user, e.g., person, is not detected at step 314, the method 300 may continue to iterate and continue to monitor for users as long as the user interface is unlocked, e.g., when the determination at step 314 in FIG. 5 is negative, the method 300 may loop back to step 310 as illustrated in FIG. 5.

When a protected user is detected, e.g., when the determination at step 330 in FIG. 5 is positive (and where step 314 is reached from a negative determination at step 312, e.g., no authorized users are present when the protected user is detected), the method 300 may include one or more remedial actions. For example, as shown at step 316 in FIG. 5, the user interface may be locked, e.g., disabled, such as user input devices may be deactivated or otherwise placed in a non-responsive state to prevent unauthorized activation of the household appliance, e.g., washer. As another example, such actions may include sounding an alarm, e.g., as illustrated at step 322 in FIG. 5 and described further below, and/or sending a notification, e.g., as illustrated at step 318 in FIG. 5. For example, the notification may be sent to a remote user interface device, such as a text message sent to a phone, an email which may be accessible on various devices, an audible notification broadcast from a smart speaker, or other suitable user notification. For example, the user notification sent to the remote user interface device may inform an absent authorized user of the presence of the protected user near the household appliance while the user interface of the household appliance is unlocked. The absent user may be, for example, an authorized or unprotected user, e.g., an adult, who may have left the area of the household appliance and/or whose attention may have been diverted from the household appliance and/or protected user.

When a protected user is detected, and an authorized user is not also detected, e.g., when the outcome of step 312 is negative and the outcome of step 314 is positive as illustrated in FIG. 5, method 300 may further include a determining step 320 of determining whether the number of protected users, e.g., protected people, detected is greater than a threshold. When the number of protected users detected is greater than the threshold, method 300 may then proceed to step 322 and provide an alarm. In various embodiments, the threshold may be one, such that whenever more than one protected user is detected, the alarm is provided, e.g., the method 300 proceeds to step 322 as illustrated in FIG. 5 whenever two or more protected users are detected. For example, when the household appliance is a washing machine appliance, the presence of more than one protected user may indicate, for example, two children playing with (in or on) the washing machine appliance, or a child attempting to bathe a pet in the washing machine appliance, etc. Thus, in such examples (among other examples, including various combinations of protected users and various household appliances, such as two children playing in an oven appliance, etc.) the presence of more than one protected user indicates a potential for additional situations, such as for one protected user to climb into the household appliance while the other protected user activates the household appliance with the first protected user therein. Accordingly, the alert of step 322, when provided, may bring one or more authorized user’s attention to a potentially urgent situation. In additional embodiments, the threshold may be two or more detected protected users.

For example, the alarm may be a local alarm, e.g., on the household appliance. In particular, the local alarm may deter or repel the protected users from touching the household appliance, and/or may encourage the protected users to move away from the household appliance.

When the number of protected users detected is less than or equal to the threshold, such as when only one protected user is detected, method 300 may then bypass the alarm step 322 and proceed to a verification step 324.

Still referring to FIG. 5, the notification at step 318 may be accompanied by or followed by a verification or confirmation message or prompt, e.g., on the remote user interface device or on a local user interface of the household appliance. If the detection is correct, e.g., if the protected user’s identity is confirmed in response to the verification or confirmation message or prompt, then the method 300 may continue to keep the user interface locked until unlocked by a verified authorized user, e.g., may skip to steps 330 and 332 as illustrated in FIG. 5 and described further below.

If, however, the protected user detection was not correct, e.g., when the determination at step 324 (such as the response to the confirmation request) is negative, then method 300 may include improving and/or updating the protected user detection software to reduce or avoid future false positives. An incorrect detection may include, for example, identifying an unprotected user as a protected user or other false positive at the protected user detection step 314 (where an unprotected user may be an authorized user or an unidentified user whose face has not been scanned and entered into the database as described above with respect to steps 304 and 306). The incorrect detection may be a learning opportunity, e.g., as described in the following, after being notified of the incorrect detection, the method may include updating or rebuilding the protected user detection software with data corresponding to the false positive, such that the household appliance learns from the incorrect detection and improves the protected user detection after the incorrect detection. For example, when the result of step 324 is negative, the method 300 may then proceed to a step 326 of rebuilding or updating the protected user detection software, e.g., by a remote computing device such as in the cloud. For example, the image or images obtained at steps 312 and/or 314 may be transmitted from the household appliance to the remote computing device at step 326, and such transmitted image or images may be used to rebuild the protected user detection software in response to the negative response received at the verification/confirmation step 324. For example, rebuilding the user detection software may include re-training a machine learning image recognition model (e.g., neural network), or otherwise updating and/or replacing an image processing, image analysis, and/or image recognition algorithm, examples of which are described in more detail below.

After rebuilding the protected user detection software, the new detection software, such as a new or updated version of the protected user detection software, may be downloaded to the household appliance, e.g., as indicated at step 328 in FIG. 5, in the same or similar manner as described above with respect to the initial or previous download at step 308.

In some embodiments, method 300 may further include steps 330 and 332 of unlocking the household appliance by or in response to the authorized user. For example, the user interface of household appliance may remain locked until unlocked by a verified authorized user. The authorized user may be verified by biometric data from the authorized user, such as the voice of the authorized user recorded at step 302. The authorized user may also or instead be verified by the remote user interface device (see, e.g., remote user interface device 1000 of FIG. 4, as described above), such as the unlocking command may be received from a mobile device, where the authorized user has logged in or otherwise authenticated on the mobile device.

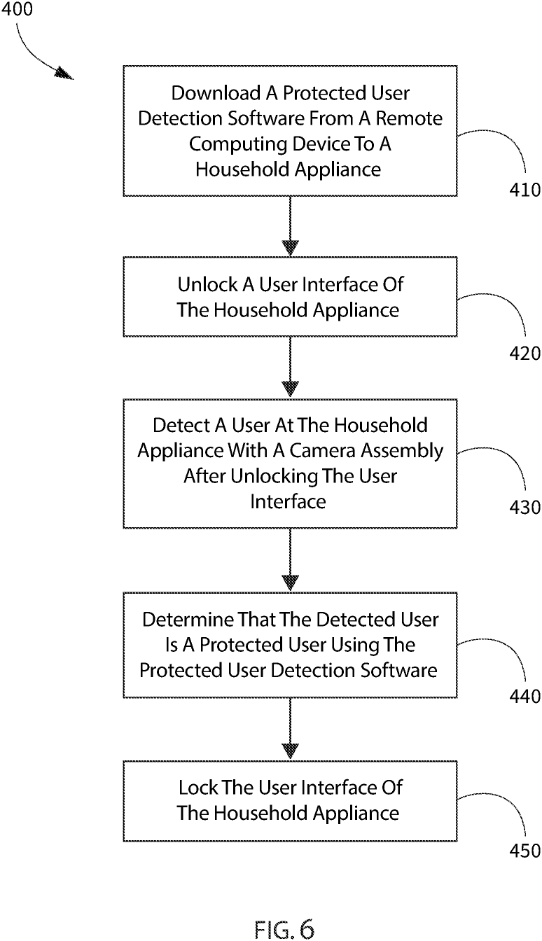

Turning now to FIG. 6, embodiments of the present disclosure may include a method 400 of operating a household appliance, such as the exemplary household appliance 10 described above. For example, the household appliance may include a camera assembly operable to obtain an image, such as but not limited to the camera assembly illustrated in FIG. 1 and described above.

As shown in FIG. 6, method 400 includes, at step 410, downloading a protected user detection software from a remote computing device to the household appliance. As noted above, the remote computing device may include a remote database, remote server, and other similar devices, which may be a distributed computing network, such as may be referred to as “the cloud,” or a part of such network.

Method 400 may also include a step 420 of unlocking a user interface of the household appliance. For example, unlocking the user interface may include permitting the household appliance, e.g., the controller 210 thereof, to activate one or more mechanical components of the household appliance in response to a user input received at the user interface panel 100.

Still referring to FIG. 6, method 400 may also include a step 430 of detecting, with the camera assembly, a user at the household appliance after unlocking the user interface. The detecting step 430 may include obtaining an image of the household appliance and/or an adjoining area in front of the household appliance using the camera assembly. For example, camera assembly 190 of household appliance 10 may obtain an image within and/or in front of the household appliance 10. In this regard, camera assembly 190 of household appliance 10 may obtain one or more images of an area in front of the household appliance, or any other zone or region within or around household appliance 10.

Method 400 may further include a step 440 of determining that the detected user is a protected user. Such determination may be made using the protected user detection software. When the detected user is a protected user, method 400 may then include a step 450 of locking the user interface of the household appliance, such as by disabling user inputs, e.g., on the user interface panel 100 of the household appliance 10, whereby the household appliance, such as mechanical components thereof (e.g., one or more heating elements, pumps, and/or motors) will not be activated in response to inputs or manipulation (e.g., button pressing) of the user input devices or user interface.

For example, steps 430 and 440 may include, and/or the household appliance may be configured for, detecting or identifying one or more users, e.g., based on one or more images. In some embodiments, detection of the user(s) may be accomplished with the camera assembly 190. For example, the household appliance may include a camera, and the method 400 may include, and/or the household appliance may be configured for, capturing an image with the camera and detecting the user(s) based on the image captured by the camera. The structure and operation of cameras are understood by those of ordinary skill in the art and, as such, the camera is not illustrated or described in further detail herein for the sake of brevity and clarity. In such embodiments, the controller 210 of the household appliance 10 may be configured for image-based processing, e.g., to detect a user and identify the user, e.g., determine whether the user is an authorized user, a protected user, or an unidentified user (e.g., neither an authorized user nor a protected user, such as not in the facial recognition database described above) based on an image of the user, e.g., a photograph taken with the camera(s) 192 of the camera assembly 190. For example, the controller 210 may be configured to identify the user by comparison of the image to a stored image of a known or previously-identified user. For example, controller 210 of household appliance 10 (or any other suitable dedicated controller) may be communicatively coupled to camera assembly 190 and may be programmed or configured for analyzing the images obtained by camera assembly 190, e.g., in order to detect a user accessing or proximate to household appliance 10 and to identify the user, e.g., determine whether the user is an authorized user or a protected user.

In some exemplary embodiments, the method 400 may include analyzing one or more images to detect and identify a user. It should be appreciated that this analysis may utilize any suitable image analysis techniques, image decomposition, image segmentation, image processing, etc. This analysis may be performed entirely by controller 210, may be offloaded to a remote server (e.g., in the cloud 1100) for analysis, may be analyzed with user assistance (e.g., via user interface panel 100), or may be analyzed in any other suitable manner. According to exemplary embodiments of the present subject matter, the analysis may include a machine learning image recognition process.

According to exemplary embodiments, this image analysis may use any suitable image processing technique, image recognition process, etc. As used herein, the terms “image analysis” and the like may be used generally to refer to any suitable method of observation, analysis, image decomposition, feature extraction, image classification, etc. of one or more images, videos, or other visual representations of an object. As explained in more detail below, this image analysis may include the implementation of image processing techniques, image recognition techniques, or any suitable combination thereof. In this regard, the image analysis may use any suitable image analysis software or algorithm to constantly or periodically monitor household appliance 10 and/or a proximate and contiguous area in front of the household appliance 10. It should be appreciated that this image analysis or processing may be performed locally (e.g., by controller 210) or remotely (e.g., by offloading image data to a remote server or network, e.g., in the cloud).

Specifically, the analysis of the one or more images may include implementation of an image processing algorithm. As used herein, the terms “image processing” and the like are generally intended to refer to any suitable methods or algorithms for analyzing images that do not rely on artificial intelligence or machine learning techniques (e.g., in contrast to the machine learning image recognition processes described below). For example, the image processing algorithm may rely on image differentiation, e.g., such as a pixel-by-pixel comparison of two sequential images. This comparison may help identify substantial differences between the sequentially obtained images, e.g., to identify movement, the presence of a particular object, the existence of a certain condition, etc. For example, one or more reference images may be obtained when a particular condition exists, and these references images may be stored for future comparison with images obtained during appliance operation. In a particular example, the reference images may be images of the face or faces of one or more authorized users and of one or more protected users, e.g., in a database as described above, such that the extant particular condition in the reference images is the presence of an authorized user and/or of a protected user. Similarities and/or differences between the reference image and the obtained image may be used to extract useful information for improving appliance performance. For example, image differentiation may be used to determine when a pixel level motion metric passes a predetermined motion threshold.

The processing algorithm may further include measures for isolating or eliminating noise in the image comparison, e.g., due to image resolution, data transmission errors, inconsistent lighting, or other imaging errors. By eliminating such noise, the image processing algorithms may improve accurate object detection, avoid erroneous object detection, and isolate the important object, region, or pattern within an image (the term “object” is used broadly herein to include humans, e.g., users of the household appliance and authorized or protected users in particular). In addition, or alternatively, the image processing algorithms may use other suitable techniques for recognizing or identifying particular items or objects, such as edge matching, divide-and-conquer searching, greyscale matching, histograms of receptive field responses, or another suitable routine (e.g., executed at the controller 210 based on one or more captured images from one or more cameras). Other image processing techniques are possible and within the scope of the present subject matter.

In addition to the image processing techniques described above, the image analysis may include utilizing artificial intelligence (“AI”), such as a machine learning image recognition process, a neural network classification module, any other suitable artificial intelligence (AI) technique, and/or any other suitable image analysis techniques, examples of which will be described in more detail below. Moreover, each of the exemplary image analysis or evaluation processes described below may be used independently, collectively, or interchangeably to extract detailed information regarding the images being analyzed to facilitate performance of one or more methods described herein or to otherwise improve appliance operation. According to exemplary embodiments, any suitable number and combination of image processing, image recognition, or other image analysis techniques may be used to obtain an accurate analysis of the obtained images.

In this regard, the image recognition process may use any suitable artificial intelligence technique, for example, any suitable machine learning technique, or for example, any suitable deep learning technique. According to an exemplary embodiment, the image recognition process may include the implementation of a form of image recognition called region based convolutional neural network (“R-CNN”) image recognition. Generally speaking, R-CNN may include taking an input image and extracting region proposals that include a potential object or region of an image. In this regard, a “region proposal” may be one or more regions in an image that could belong to a particular object (e.g., a human or animal face, such as the face of an authorized user and/or of a protected user) or may include adjacent regions that share common pixel characteristics. A convolutional neural network is then used to compute features from the region proposals and the extracted features will then be used to determine a classification for each particular region.

According to still other embodiments, an image segmentation process may be used along with the R-CNN image recognition. In general, image segmentation creates a pixel-based mask for each object in an image and provides a more detailed or granular understanding of the various objects within a given image. In this regard, instead of processing an entire image-i.e., a large collection of pixels, many of which might not contain useful information-image segmentation may involve dividing an image into segments (e.g., into groups of pixels containing similar attributes) that may be analyzed independently or in parallel to obtain a more detailed representation of the object or objects in an image. This may be referred to herein as “mask R-CNN” and the like, as opposed to a regular R-CNN architecture. For example, mask R-CNN may be based on fast R-CNN which is slightly different than R-CNN. For example, R-CNN first applies a convolutional neural network (“CNN”) and then allocates it to zone recommendations on the covn5 property map instead of the initially split into zone recommendations. In addition, according to exemplary embodiments, standard CNN may be used to obtain, identify, or detect any other qualitative or quantitative data related to one or more objects or regions within the one or more images. In addition, a K-means algorithm may be used.

According to still other embodiments, the image recognition process may use any other suitable neural network process while remaining within the scope of the present subject matter. For example, the steps of detecting and identifying a user may include analyzing the one or more images using a deep belief network (“DBN”) image recognition process. A DBN image recognition process may generally include stacking many individual unsupervised networks that use each network’s hidden layer as the input for the next layer. According to still other embodiments, the step of analyzing one or more images may include the implementation of a deep neural network (“DNN”) image recognition process, which generally includes the use of a neural network (computing systems inspired by the biological neural networks) with multiple layers between input and output. Other suitable image recognition processes, neural network processes, artificial intelligence analysis techniques, and combinations of the above described methods or other known methods may be used while remaining within the scope of the present subject matter.

In addition, it should be appreciated that various transfer techniques may be used but use of such techniques is not required. If using transfer techniques learning, a neural network architecture may be pretrained such as VGG16 / VGG19 / ResNet50 with a public dataset then the last layer may be retrained with an appliance specific dataset. In addition, or alternatively, the image recognition process may include detection of certain conditions based on comparison of initial conditions, may rely on image subtraction techniques, image stacking techniques, image concatenation, etc. For example, the subtracted image may be used to train a neural network with multiple classes for future comparison and image classification.

It should be appreciated that the machine learning image recognition models may be actively trained by the appliance with new images, may be supplied with training data from the manufacturer or from another remote source, or may be trained in any other suitable manner. For example, according to exemplary embodiments, this image recognition process relies at least in part on a neural network trained with a plurality of images of the appliance in different configurations, experiencing different conditions, or being interacted with in different manners, such as by different users. This training data may be stored locally or remotely and may be communicated to a remote server for training other appliances and models.

It should be appreciated that image processing and machine learning image recognition processes may be used together to facilitate improved image analysis, object detection, or to extract other useful qualitative or quantitative data or information from the one or more images that may be used to improve the operation or performance of the appliance. Indeed, the methods described herein may use any or all of these techniques interchangeably to improve image analysis process and facilitate improved appliance performance and consumer satisfaction. The image processing algorithms and machine learning image recognition processes described herein are only exemplary and are not intended to limit the scope of the present subject matter in any manner.

In some embodiments, the analysis of the image and user identification, e.g., the determination of whether the detected user is a protected user (or authorized user or unidentified user), may be performed using a protected user detection software. The protected user detection software may be built by a remote server, e.g., in the cloud, and may further be updated and/or re-built with additional inputs at subsequent user detections. For example, the protected user detection software may be trained using one or more user inputs. Thus, in some embodiments, e.g., at initial or prior user detection events, the determination that the detected user is a protected user may include receiving a user input that indicates the detected user is a protected user. Such user input may include a user confirmation provided in response to the notification, such as a confirmation or verification that the protected user was identified correctly.

When the household appliance receives such user input(s) and thus determines that the user is a protected user, the household appliance may then gather data, e.g., obtain images with one or more cameras. The household appliance may also or instead gather such data in response to an incorrect detection. The gathered data may be used to rebuild or update the protected user detection software. For example, the protected user detection software may be built by a remote server, e.g., in the cloud, and downloaded by the household appliance, such as transmitted from the remote server and received by the household appliance. Then, at a subsequent protected user detections (which may be determined automatically, e.g., by analyzing sensor input such as camera images, and/or based on manual user input) additional data may be gathered and such additional data may be sent to the cloud, such as transmitted from the household appliance and received by the remote server. The remote server may then use the additional data to update and/or rebuild the protected user detection software. The updated protected user detection software may then be transmitted to, e.g., re-downloaded by, the household appliance. Accordingly, the protected user detection software may be continuously updated and the accuracy of the protected user detection software may be continuously improved with additional data. In particular, the remote server may be in communication with numerous household appliances, may receive data from multiple of the household appliances, and may update the protected user detection software based on all the data from the multiple household appliances.

Thus, in some embodiments, method 400 may also include transmitting the input obtained from the camera at step 430 to a remote server from the household appliance after receiving the user input. In such embodiments, method 400 may further include building a protected user detection software by the remote server based on the input obtained from the camera. The protected user detection software may then be transmitted from the remote server to the household appliance. For example, method 400 may include steps of receiving biometric data for one or more authorized users and receiving biometric data for one or more protected users. The biometric data for both classes of users may include facial recognition images. The biometric data for at least the authorized users may also include a voice print or voice recognition data. The biometric data for both classes of users may then be transmitted to the cloud, e.g., one or more remote computing devices. For example, method 400 may also include transmitting the received biometric data for the one or more authorized users and the received biometric data for the one or more protected users to the remote computing device. Method 400 may also, in some embodiments, include building, by the remote computing device, the protected user detection software, such as using the transmitted biometric data to build (or re-build or update) the protected user detection software.

Further embodiments may include both initially downloading the protected user detection software from the remote server prior to detecting the protected user, followed by uploading the input obtained at step 430, e.g., transmitting the images obtained from the camera, to the remote server from the household appliance after correctly or incorrectly identifying the protected user (by analyzing the input locally and/or by receiving a user input indicating that the detected user is a protected user). Thus, the protected user detection software may then be updated or rebuilt by the remote server, and the updated or rebuilt protected user detection software may be downloaded by the household appliance for use in a subsequent operation.

In some exemplary embodiments, method 400 may further include sending a notification to a remote user interface device after determining that the detected user is a protected user. The method 400 may then include receiving a response to the notification. In particular, when the response is a negative response, e.g., when the response is or includes an incorrect detection input (such as a selection of “NO” in response to a prompt), method 400 may include, after receiving the incorrect decision input, transmitting the one or more images to the remote computing device from the household appliance. In such embodiments or instances, the method 400 may then include updating the protected user detection software by the remote computing device based on the one or more transmitted (e.g., uploaded) images and then downloading the updated protected user detection software from the remote computing device to the household appliance.

In some exemplary embodiments, method 400 may also include an alarm step in response to more than one protected user. For example, the user detected at step 430 as described above may be a first user and may further be a first protected user, e.g., as determined at step 440 as described above. In such instances, method 400 may further include detecting a second user at the household appliance after unlocking the user interface of the household appliance. The second user may be detected with the camera assembly, e.g., in the same or similar manner as the first user as described above. When the second user is detected, the method 400 may also include determining that the second detected user is a second protected user, e.g., using the protected user detection software to identify the second user as a protected user. When more than one protected user is detected, e.g., after determining that the second detected user is the second protected user, the method 400 may include activating an alarm.

In some embodiments, the household appliance may remain unlocked as long as at least one authorized user is present, e.g., it may be presumed that the authorized user is supervising or monitoring any protected users that may also be present. Thus, for example, the step 430 of detecting the user may include detecting more than one user. In such embodiments, the step 440 of determining whether the detected user is the protected user may include determining whether each detected user is a protected user. In such embodiments, the step 450 of locking the user interface may only be performed when every detected user is a protected user, such as when two users are detected and both detected users are protected users. As a contrasting example, when two or more users are detected and at least one detected user is an authorized user, then the user interface of the household appliance may remain unlocked, for example when three users are detected and at least one is an authorized user, even when the other two (or more) detected users are protected users.

In some embodiments, method 400 may also include secure unlocking of the user interface after locking the user interface at step 450. For example, method 400 may further include receiving an unlock command. The unlock command may be, for example, a voice command or may be a mobile command (e.g., received from a remote user interface device), as described above with reference to step 330 in FIG. 5. The unlock command may be verified using biometric data, e.g., method 400 may include verifying the unlock command based on the received biometric data for the one or more authorized users. For example, the unlock command may be verified based on recognizing the authorized user’s voice, such as when the unlock command is a voice command. As another example, the unlock command may be verified based on a fingerprint scan or other biometric scan (e.g., iris scan or face scan) using a camera or other component of the remote user interface device, such as when the unlock command is a mobile command, such as using a camera of a smartphone to obtain an image of the user’s face when the unlock command is a mobile command. In such embodiments, method 400 may then include unlocking the user interface in response to the received unlock command after verifying the unlock command.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of operating a household appliance, the household appliance comprising a camera assembly operable to obtain an image, the method comprising:
downloading a protected user detection software from a remote computing device to the household appliance;
unlocking a user interface of the household appliance;
detecting, with the camera assembly, a user at the household appliance after unlocking the user interface of the household appliance;
determining, using the protected user detection software, whether the detected user is a protected user; and
locking the user interface of the household appliance in response to determining that the detected user is the protected user.

2. The method of claim 1, further comprising sending a notification to a remote user interface device after determining that the detected user is the protected user.

3. The method of claim 2, further comprising receiving a response to the notification.

4. The method of claim 3, wherein the response comprises an incorrect detection input.

5. The method of claim 4, wherein detecting the user at the household appliance comprises obtaining one or more images with the camera assembly, wherein determining that the user is the protected user is based on the one or more images, further comprising, after receiving the incorrect decision input, transmitting the one or more images to the remote computing device from the household appliance.

6. The method of claim 5, further comprising updating the protected user detection software by the remote computing device based on the one or more images, and downloading the updated protected user detection software from the remote computing device to the household appliance.

7. The method of claim 1, further comprising:
detecting, with the camera assembly, a second user at the household appliance after unlocking the user interface of the household appliance;
determining, using the protected user detection software, that the second detected user is a second protected user; and
activating an alarm after determining that the second detected user is the second protected user.

8. The method of claim 1, wherein the step of detecting the user comprises detecting more than one user, the step of determining whether the detected user is the protected user comprises determining whether each detected user is a protected user, and wherein the step of locking the user interface is only performed when every detected user is a protected user.

9. The method of claim 1, further comprising, prior to downloading the protected user detection software:
receiving biometric data for one or more authorized users;
receiving biometric data for one or more protected users;
transmitting the received biometric data for the one or more authorized users and the received biometric data for the one or more protected users to the remote computing device; and
building, by the remote computing device, the protected user detection software.

10. The method of claim 9, further comprising, after locking the user interface:
receiving an unlock command;
verifying the unlock command based on the received biometric data for the one or more authorized users; and
unlocking the user interface in response to the received unlock command after verifying the unlock command.

11. A household appliance, comprising:
a camera assembly operable to obtain an image; and
a controller, the controller operable for:
downloading a protected user detection software from a remote computing device to the household appliance;
unlocking a user interface of the household appliance;
detecting, with the camera assembly, a user at the household appliance after unlocking the user interface of the household appliance;
determining, using the protected user detection software, whether the detected user is a protected user; and
locking the user interface of the household appliance in response to determining that the detected user is the protected user.

12. The household appliance of claim 11, wherein the controller is further operable for sending a notification to a remote user interface device after determining that the detected user is a protected user.

13. The household appliance of claim 12, wherein the controller is further operable for receiving a response to the notification.

14. The household appliance of claim 13, wherein the response comprises an incorrect detection input.

15. The household appliance of claim 14, wherein the controller is operable for detecting the user at the household appliance by obtaining one or more images with the camera assembly, and is operable for determining that the user is the protected user based on the one or more images, wherein the controller is further operable for, after receiving the incorrect decision input, transmitting the one or more images to the remote computing device.

16. The household appliance of claim 15, wherein the controller is further operable for downloading an updated protected user detection software from the remote computing device after transmitting the one or more images to the remote computing device.

17. The household appliance of claim 11, wherein the controller is further operable for:
detecting a second user at the household appliance after unlocking the user interface of the household appliance;
determining, using the protected user detection software, that the second detected user is a second protected user; and
activating an alarm after determining that the second detected user is the second protected user.

18. The household appliance of claim 11, wherein the step of detecting the user comprises detecting more than one user, the step of determining whether the detected user is the protected user comprises determining whether each detected user is a protected user, and wherein the controller is operable for locking the user interface only when every detected user is a protected user.

19. The household appliance of claim 11, wherein the controller is further operable for, prior to downloading the protected user detection software:
receiving biometric data for one or more authorized users;
receiving biometric data for one or more protected users; and
transmitting the received biometric data for the one or more authorized users and the received biometric data for the one or more protected users to the remote computing device.

20. The household appliance of claim 19, wherein the controller is further operable for, after locking the user interface:
receiving an unlock command;
verifying the unlock command using the protected user detection software; and
unlocking the user interface in response to the received unlock command after verifying the unlock command.
